(19) United States
(12) Patent Application Publication
(10) Pub. No.: US 2025/0270723 A1
(43) Pub. Date: Aug. 28, 2025

(54) ELECTROLYSER AND METHOD FOR OPERATING AN ELECTROLYSER

(71) Applicant: Siemens Energy Global GmbH & Co. KG, München (DE)

(72) Inventors: Alexander Tremel, Möhrendorf (DE); Markus Ungerer, Baiersdorf (DE); Du-Fhan Choi, Düsseldorf (DE); Bernd Merkl, Igensdorf (DE)

(21) Appl. No.: 18/847,438

(22) PCT Filed: Jan. 11, 2023
(86) PCT No.: PCT/EP2023/050526

§ 371 Date: Sep. 16, 2024

(30) Foreign Application Priority Data
Mar. 31, 2022 (DE) 10 2022 203 191.1

(51) Int. Cl. C25B 15/08; C25B 1/04; C25B 9/70

(52) U.S. Cl. CPC C25B 15/087; C25B 1/04; C25B 9/70

(57) ABSTRACT

The invention relates to an electrolyser for generating hydrogen (H2) and oxygen (O2) as product gases, said electrolyser including an electrolysis module and a gas separator which is designed for phase separation of the product gas from water, the electrolysis module being connected to the gas separator via a product flow line for the product gas, and a return line, which connects the gas separator to the electrolysis module, being provided for the separated water. The gas separator is designed and positioned at a height difference (Δh) above the electrolysis module in such a way that, in the event of a standstill, the electrolysis module can be automatically flooded with water, driven solely by the height difference (Δh). The invention also relates to a method for operating an electrolyser including an electrolysis module, wherein, in a standstill mode, the electrolysis current is stopped, and a safety deactivation is initiated.

### BACKGROUND

The invention relates to an electrolyzer and to a method of operating an electrolyzer.

An electrolyzer is an industrial plant that brings about electrochemical conversion of matter with the aid of electrical current, called electrolysis. In accordance with the variety of different electrolyses, there is also a variety of electrolyzers, for example an electrolyzer for water electrolysis, i.e. the breakdown of water as reactant into hydrogen and oxygen product gases.

There have been increased considerations for some time as to production of materials of value with surplus energy from renewable energy sources in periods with a lot of sun and a lot of wind, i.e. with above-average generation of solar power or wind power. A material of value may especially be hydrogen, which is produced with water electrolyzers. Hydrogen gas can be produced, for example, in what is called the PtG (power-to-gas) process.

An electrolyzer generally has a multitude of electrolysis cells adjacent to one another in a stacked arrangement. By means of water electrolysis, water is broken down in the electrolysis cells to hydrogen and oxygen. In a PEM electrolyzer, water distilled on the anode side is typically supplied as reactant and split into hydrogen and oxygen at a proton-permeable membrane (proton exchange membrane; PEM). Meanwhile, the water is oxidized to oxygen at the anode. The protons pass through the proton-permeable membrane. Hydrogen is produced on the cathode side. Meanwhile, the water is generally conveyed from a bottom side into the anode space and/or cathode space.

In an electrolyzer, the individual electrolysis cells are typically stacked to form a module having a multitude of individual cells in an axial direction and assembled to form the module or electrolysis module. An electrolyzer typically has a multitude of modules that collectively form what is called an electrolysis stack or simply stack. For example, 50 electrolysis cells may be stacked axially to form a module and in turn, for example, 5 modules may be stacked in axial direction to form a stack, such that an electrolysis stack of this kind may therefore include 250 cells, for example, in an axial overall assembly.

As soon as the electrolysis modules in a PEM electrolyzer, or the electrolysis cells or the electrolysis stack, are filled with water for the first time, for example after manufacture, it has to be ensured that water (reactant water), or a water-gas mixture in operation of the electrolyzer, always remains in the modules. Running-dry or drying-out has to be prevented in every phase of operation since this would lead to irreversible damage to the electrolyzer. The membrane in particular must always be kept in a moist medium, but there are other functional parts and components, for instance the catalyst or the electrodes, that must not dry out either.

In a phase of operation with a planned and pending maintenance or service of the electrolyzer from a normal state of operation, for instance for servicing purposes, shutdown management of the electrolyzer is generally efficiently plannable in advance, and appropriate precautions and shutdown procedures can be initiated in a routine and safe manner, such that, in particular, even after shutdown, water remains in the modules and can additionally also be circulated.

By contrast, unforeseen and in particular safety-related rapid shutdowns at short notice or even instantaneous emergency shutdowns in the event of faults can present considerable problems. It is not only that these are quite difficult to control, with a high level of technical complexity, particularly with regard to preventing the modules from running dry in shutdown operation. This is all the more true in that there are different types of electrolyzers each with different construction and different operating parameters, with which specific operation risks and causes for a safety shutdown or an emergency shutdown have to be taken into account. For instance, there are known atmospheric electrolyzers that work at an atmospheric or only low operating pressure, but also pressure electrolyzers that work at a high operating pressure of 35 bar or higher.

### SUMMARY

It is therefore an object of the invention to specify an electrolyzer where shutdown operation is implementable in a technically simple and safe manner, such that running-dry is prevented. A further object is that of specifying a method of operating an electrolyzer in shutdown operation with low propensity to failure and high flexibility.

The object directed to an electrolyzer is achieved in accordance with the invention by an electrolyzer for production of hydrogen and oxygen as product gases, having an electrolysis module and having a gas separator designed for phase separation of the product gas from water, in which the electrolysis module is connected to the gas separator via a product flow conduit for the product gas, and in which a return conduit having a delivery pump for the water removed is provided, which connects the gas separator to the electrolysis module, wherein the gas separator is designed and disposed at a height differential above the electrolysis module such that, in the event of a shutdown, the electrolysis module is automatically floodable with water, driven solely by the height differential, where the delivery pump at shutdown has a small pressure drop coefficient such that, acting together with the gas separator which is emptiable via the return conduit, rapid flooding in the shut-down state is assured.

The invention proceeds from a recognition of the problem originating from a risk assessment and appraisal of different causes in that, for instance in the case of electrolysis modules at least partly filled with gas and with hydrogen on the cathode side and oxygen on the anode side, very rapid diffusion of the gases through the thin proton-permeable membrane takes place. Particularly hydrogen, which is a small molecule, then diffuses back onto the oxygen side. The effect is more pronounced when the operating pressure of the electrolyzer is higher, since a partial pressure differential is the driving force for the diffusion. The diffusion can lead to a hazardous gas concentration within minutes, i.e. to an increase in the hydrogen concentration on the oxygen side to above the lower explosion limit of 4 vol %. Since a source of ignition cannot be ruled out, for example a dried-out catalyst, an explosion is possible in the worst case.

The electrolysis modules must always be prevented from running dry in this situation.

In normal operation, a mixed phase is formed in the modules, i.e. a phase mixture of water and product gas. As soon as the power supplied to the electrolysis is stopped and no further measures are taken, the mixture would soon separate and a gas phase would form at least in the upper region of the electrolysis modules. Rapid supply of water and displacement of the gas is therefore also absolutely necessary in all conceivable fault scenarios in order to prevent drying-out. Safeguarding measures therefore have to be implemented immediately.

An additional factor is that it is a development goal in PEM electrolysis to use ever thinner membranes, which reduces electrical resistance and increases the efficiency of the electrolyzer. However, thinner membranes lead disadvantageously to even higher diffusion and hence to an increase in any possible explosion risk.

It is therefore increasingly important in an electrolyzer to ensure particularly rapid flooding of the electrolysis modules with water in shutdown operation. The existing solutions are inadequate here or very complex and not very flexible with regard to the working pressure of the electrolyzer.

In this regard, the invention proposes, for the electrolyzer, a flooding concept for the electrolysis modules which is completely autonomous and intrinsically very reliable. It is independent of additional and complex external supplies and redundant systems or backup solutions for conveying or flooding by means of pumps. This system concept for the electrolyzer is advantageously usable independently of the working pressure of the electrolyzer, i.e. is flexibly applicable both to atmospheric electrolyzers and to pressure electrolyzers. In particular, it is possible to avoid critical states of operation, for instance via an explosion risk, and at the same time to prevent running-dry since rapid emptying of the gas separator is automatically brought about and driven by balancing of levels owing to the height differential and hence the pressure differential correspondingly maintained as a result of the water column. In particular, there is no need for external pump aggregates, or those that are maintained specially for the purpose, and for complex electrical emergency supply systems in order to bring about reliable and very rapid flooding of the electrolysis modules. The electrolysis cells and in particular the membrane are thus protected, since these components are flooded and kept moist by water flowing back through the return flow conduit. By design and arrangement of the gas separator at a height above the electrolysis module, in operation, a fill level height or a level of the water in the gas separator is maintained and a hydrostatic conveying pressure is already implemented in the system, provided for shutdown operation, especially in the case of an emergency shutdown for safety reasons. It will be appreciated that the flooding concept is also advantageously utilizable for regular and planned shutdown, for instance for service purposes.

As well as the height differential maintained into the return conduit, a delivery pump is connected, which, at shutdown, has a small or very small pressure drop coefficient, such that particularly rapid flooding is brought about in the return conduit via the combination of the pressure differential maintained owing to the height difference established and the configuration of the delivery pump.

The pressure drop coefficient or else resistance coefficient (typical formula symbol ζ—zeta), in fluid mechanics, is a dimensionless measure of pressure drop in a flow component, such as a pipeline or fitting. This means that the pressure drop coefficient makes a statement as to what pressure difference has to exist between inflow and outflow in order to maintain a particular flow through the component. The pressure drop coefficient is always applicable to a particular geometric shape and is generally dependent on the Reynolds number and in some cases on the surface roughness of the flow-conducting component.

In normal operation of the electrolyzer, it is very advantageous to actively return the water separated in the gas separator into the electrolysis process, and therefore a delivery pump is provided in the return conduit, which pumps the water back. However, the delivery pump is a resistance-affected flow element which, in shutdown operation, for example, counteracts rapid backflow of the water in the flooding operation. It is therefore advantageous to provide a very low pressure drop coefficient at shutdown for the delivery pump, such that rapid flooding and flow-through the return conduit is achievable with the delivery pump even in the shut-down state.

This plant concept for an electrolyzer therefore enables reliable and rapid flooding of the electrolysis modules with water by virtue of the elevated level of the gas separators. The present safety concept is superior to known solutions for electrolyzers since it does not require redundancy, and supplies are implementable irrespective of the working pressure of the electrolyzer.

For instance, pressure electrolyzers are operated at a pressure of 35 bar, for example. At this high working pressure, the volumetric gas content in the electrolysis module is low, meaning that only a small amount of gas can separate in volumetric terms after the shutdown. The pipelines from the electrolysis module generally ascend to the gas separators, such that, after shutdown, water can partly separate even in the pipelines and flow back into the electrolysis module. However, this does not take place sufficiently rapidly in the event of an emergency shutdown, for instance in the event of a risk of explosion, and, moreover, requires active components in order to convey the water actively and rapidly into the electrolysis modules. It is also necessary to accordingly maintain an appropriate fill level in the gas separator for this situation. By virtue of operation under pressure, the diffusion of hydrogen from the cathode side through the membrane to the anode side of the electrolysis cell is increased, which is a safety-relevant problem that is increased as membranes are increasingly being designed more thinly.

By comparison with a pressure electrolyzer, in the case of an electrolyzer in atmospheric operation, there is a large volumetric amount of gas in the electrolysis module under operating conditions. The electrolysis modules are connected directly to gas separators above both via the inlet and the outlet. It is generally unnecessary to install a pump because of the natural circulation process. If there is still a sufficient amount of sufficiently dispersed gas in the electrolysis modules, this natural circulation does not stop because of the difference in density caused thereby. After natural circulation has stopped, the water level in the electrolysis modules is well below that of the gas separators, and there are no significantly pressure drop-affected internals in between, such that water can run freely from the gas separators into the modules and can ensure the water level in the modules.

A conventional means of safeguarding fault scenarios in the case of forced circulation by means of pumps is the utilization of redundant pumps. In the case of a fault in a pump, the remaining pump capacity can be utilized in order to rapidly fill the modules with water. An uninterrupted power supply is needed in order to be able to counteract a power outage as well. Moreover, pumps should be actuated completely separately in order to be able to bypass control technology faults as well. All of this makes such solutions very complex and costly.

The concept of the invention, by contrast, can very effectively safeguard both pressure electrolyzers and atmospheric electrolyzers against running dry, and particularly rapid and autonomous flooding is possible without requirements for redundancy. The concept is found to be particularly advantageous in the case of atmospheric electrolyzers, but, as explained, is not limited thereto.

In one embodiment, the electrolyzer, the gas separator is configured as a horizontal vessel, such that a large surface area is provided as phase interface between liquid and gaseous phases.

This configuration of the electrolyzer permits a comparatively low overall build height of the gas separator, which is very advantageous in view of the height differential to be provided above the electrolysis module. The gas separator configured as a vessel accordingly has a vessel base having a length dimension and a width dimension, each of which is much greater than the vessel height. This saves build space in spite of the height differential required. Moreover, the horizontal design creates a correspondingly large phase interface in the gas separator between the water at the vessel base and product gas-oxygen or hydrogen—in the gas phase above the phase boundary, which in normal operation promotes more effective phase separation between water and product gas in the phase mixture.

In one embodiment, the return conduit opens into a lower region of the electrolysis module.

This mode of connection of the return conduit provides a maximum hydrostatic pressure differential as a result of the difference in height between the gas separator and the electrolysis module in the electrolyzer. A higher differential pressure ensures faster backflow of the water and complete flooding of the electrolysis module in the event of a safety shutdown. The differential pressure results simply from the hydrostatic pressure of the water column which is generated in the event of a height differential between the normal fill level in the gas separator and the level of the connection of the return conduit into the electrolysis module. The driving force for the flooding is the higher water level in the gas separator compared to the electrolysis module, such that automatic level balancing can be brought about.

The height differential is preferably adjusted such that the driving pressure differential provided for the flooding is at least 0.05 bar to 0.5 bar, especially 0.1 bar.

In terms of plant design, it has been found that, with this pressure differential in the case of typical electrolyzers, a sufficient driving pressure force for level balancing has generally been provided in order to initiate flooding as fast as possible when required. The sufficient differential pressure level and hence the higher positioning of the gas separator compared to the electrolysis module is advantageously adaptable to the respective situation, and it is also possible to take account of conduit cross sections, component parts and components that affect flow resistances in the return flow conduit and in the entire electrolysis module to be flooded. This can lead to altered pressure differentials and possibly higher required pressure differentials.

It has been found that the pressure drop coefficient ζ of the delivery pump is preferably less than ζ=5, especially less than ζ=3. This provides throughflow or backflow of a sufficient volume flow rate of water through the delivery pump even at shutdown. However, the driving force remains the differential pressure as a result of the difference in height between gas separator and electrolysis module. But now a correspondingly adjusted and designed delivery pump has advantageously been integrated into the electrolysis plant, which passively assists the flooding via the low pressure drop coefficient.

In one embodiment, two or more electrolysis modules have been provided, which are connected to the gas separator via a common product flow conduit.

The output of the electrolyzer or of the electrolysis plant is thus scalable in a simple and flexible manner by providing further electrolysis modules. The electrolysis modules may be operated in a parallel connection or else in series connection as what are called module rows or combinations thereof. With regard to terminology, a parallel connection may relate to the purely electrical interconnection with regard to the electrolysis current or electrolysis voltage and/or with regard to the streams of matter, for instance the guiding and directing of the process water as reactant stream through the electrolysis modules.

In one embodiment, in the case of multiple electrolysis modules, the electrolysis modules are connected to the return conduit via a respective terminal conduit, with a closed-loop control valve disposed in at least one of the terminal conduits. Preference is given here to a configuration in which a respective closed-loop control valve is provided in each of the terminal conduits, since this enables particularly high operational flexibility, for instance the flooding of only one or only individual electrolysis modules where required for service purposes or in a safety shutdown.

If, for instance, multiple parallel-connected electrolysis modules or module rows are supplied by a pump or pump station, respective closed-loop control valves are therefore preferably provided in order to enable individually controllable flow to each electrolysis module or each module row.

In the case of use of multiple parallel pumps, for instance for provision of redundancy, it is preferable that the flow through a pump is also of sufficient size, i.e. the pressure drop coefficient. This advantageously permits, for example, what is called the gating-off and exchange of pumps and further operation with at least one pump through which free flow is possible. A gate valve—also called gas or water valve—is a fitting which is usually utilized for complete opening or closure of the entire flow cross section of a pipe or conduit. By contrast with valves, gate valves are not used primarily for regulation of flow rate and not at very high pressure. Gate valves often serve as a primary barrier, i.e. in order to enable maintenance work on downstream fittings that assume the gating or regulation function in regular operation.

In the design concept of the invention for the electrolysis plant, there is generally a reduction in the permissible pressure drop coefficient at the component level when additional components are used in the flow pathway, for example heat transferers, valves, filters. This may advantageously be compensated for, at least within certain limits, by adjustment of the height differential, i.e. with a correspondingly higher differential pressure as driving force for the flooding.

The closed-loop control valve is preferably mechanically designed for a minimum flow below which the flow must not be reduced under closed-loop control. The minimum opening may be implemented by a corresponding mechanical barrier. A corresponding configuration of the closed-loop control valve is preferably also provided in the case of multiple closed-loop control valves that are each connected into a terminal conduit.

This minimum opening of the valve setting for a minimum flow through the closed-loop control valve is advantageous together with the pressure drop coefficient of the delivery pump and/or the pressure drop coefficient of a pump station having multiple pumps which are set up and designed in the electrolyzer so as to ensure sufficiently rapid automatic backflow of water from the gas separator to the electrolysis module to be flooded solely on the basis of the differential pressure or height differential.

The object directed to a method is achieved in accordance with the invention by a method of operating an electrolyzer, in which an electrolysis stream is supplied to an electrolysis module in regular operation, such that water is converted to hydrogen and oxygen as product gases in the electrolysis module, wherein product gas is fed to a gas separator in a phase mixture of water and product gas, wherein water is separated from product gas in the gas separator, and wherein, in shutdown operation, the electrolysis stream is stopped and a safety shutdown is initiated. In shutdown operation here, water is driven out of the gas separator automatically through the return conduit into the electrolysis module solely on account of a height differential, wherein water flows through the shut-down delivery pump and the electrolysis module is flooded, wherein rapid flooding is ensured in the shut-down state.

The electrolysis module is preferably flooded automatically here with water until the fill level of water in the gas separator and the electrolysis module is balanced.

In the event of a sudden stoppage of operation, for example as a result of a safety shutdown or an emergency shutdown of the electrolysis, product gas and water will separate in the electrolysis module. A certain water level or fill level will be established in the electrolysis module. Because the gas separator is higher, water will be immediately and rapidly driven into the electrolysis module because of the differential pressure that exists, and there can even be sufficiently rapid flow through flow elements present in the conduits. Balancing of levels is thus brought about very rapidly and automatically, and rapid flooding of the electrolysis module is achieved. The electrolysis cells in the electrolysis module and in particular the sensitive membranes are fully soaked with water and cannot dry out. Running-dry is reliably prevented.

Further advantages of the method will be correspondingly apparent from the above-described advantages of the electrolyzer.

### BRIEF DESCRIPTION OF THE DRAWINGS

The invention is elucidated in detail hereinafter by the drawings that follow. It should be noted here that the working examples shown in the drawings serve primarily to illustrate the invention. However, they are not intended to restrict the invention.

The figures show, in schematic and highly simplified form:

FIG. 1 an electrolyzer with an electrolysis module;

FIG. 2 an electrolyzer with two or more electrolysis modules;

FIG. 3 a diagram showing the progression of the fill level over time in the event of a safety shutdown.

Identical reference numerals in the figures have the same meaning.

### DETAILED DESCRIPTION

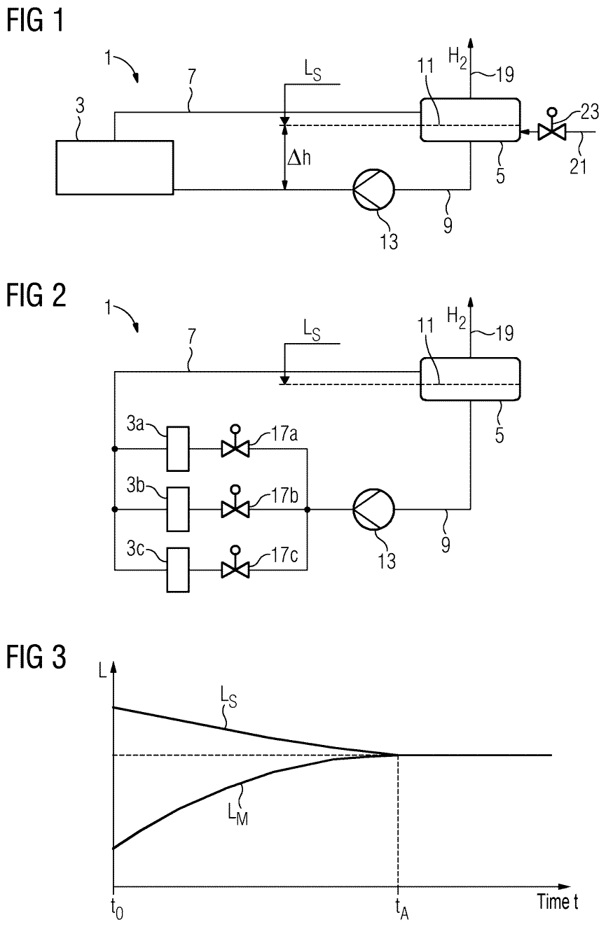

FIG. 1 shows an electrolysis plant 1 for the electrolysis of water. The electrolyzer 1 has—in simplified form in the diagram—a circuit on the hydrogen side. A corresponding circuit is also possible in analogous consideration on the oxygen side. This is a simple working example of an electrolyzer 1 in order to execute the invention and to elucidate the principle. The electrolyzer 1 has an electrolysis module 3 and a gas separator 5. The gas separator 5 is connected to the electrolysis module 3 via a product flow conduit 7. The electrolysis module 3 typically includes an electrolysis cell stack, not shown in detail in FIG. 1, with a multitude of electrolysis cells stacked in axial direction. An anodic half-cell and the cathodic half-cell of an electrolysis cell are separated by a proton-permeable membrane. It is also possible that multiple electrolysis modules 3 are connected to form a module group. The electrolyzer 1 is configured for production of hydrogen H2 and oxygen O2 as product gases in a PEM electrolysis process, for example under atmospheric pressure conditions. The electrolysis module 3 is connected to the gas separator 5 via the product flow conduit 7 for the product gas. The gas separator 3 is designed for phase separation of the product gas from water, in the present case for separation of gaseous hydrogen H2 from the phase mixture with water in the gas separator 3. A return conduit 9 for the water removed fluidically connects the gas separator 3 to the electrolysis module 3. The return conduit 9 opens into the electrolysis module 3 at a connection site as low as possible, so as to achieve a correspondingly maximum hydrostatic pressure through the water column in the gas separator 5 in relation to the fill level LS. A delivery pump 13 is connected into the return conduit 9, which actively delivers or circulates water separated from the phase mixture in normal operation of the electrolyzer from the gas separator 3 into the electrolysis module 3. The delivery pump 13 is supplied with electrical power.

With this simple circuit in FIG. 1, in normal operation of the electrolysis module 3, the latter is supplied with water for the electrolysis reaction, where the water simultaneously also serves to cool the cells. As product gas from the electrolysis, hydrogen generated is conducted together with excess water in a phase mixture into the gas separator 3 for hydrogen. A phase separation takes place in the gas separator 3, and the gaseous hydrogen is separated from the liquid water, withdrawn from the circuit via the gas conduit 19 for the hydrogen H2, and sent to a further use. In order to maintain the circulation of water in the circuit, the delivery pump 4 is provided in the circuit. Consumed water is additionally compensated for by replenishing demineralized water, called “DM water”, into the gas separator 3 in a controlled manner via a feed conduit 21 with a closed-loop control fitting 23.

The gas separator 5 is designed and disposed at a height differential Δh above the electrolysis module 3 such that, in the event of shutdown, the electrolysis module 3 is floodable automatically with water, driven solely by the height differential Δh. The height differential Δh is set here such that the driving pressure differential available between the fill level LM in the electrolysis module 3 and the fill level LS in the gas separator 3 is at least 0.05 bar to 0.5 bar, especially 0.1 bar; see FIG. 3 in this regard, in which the principle of level balancing is illustrated.

The flooding concept for the electrolysis module 3 is entirely autonomous and intrinsically very reliable. It is independent of additional and complex external supplies and redundant systems or backup solutions for conveying or flooding by means of pumps. By design and arrangement of the gas separator 5 at a sufficient height above the electrolysis module 3, in operation, a fill height LS or a level LS of the water is regularly maintained in the gas separator 5, and a hydrostatic delivery pressure is already intrinsically provided in the system for any necessary shutdown operation, especially in the event of a safety-related emergency shutdown. The flooding concept is of course also advantageously utilizable for a regular and planned shutdown, for instance for servicing purposes.

The gas separator 5 is configured here as a horizontal vessel with a maximum surface area 11 as phase interface, as a result of which particularly effective phase separation and reduced build space in terms of build height in particular is possible, in spite of an elevated arrangement of the gas separator 5 compared to the electrolysis module 3 at the height differential Δh. The delivery pump 13 in the return conduit 9 is designed such that it has a low pressure drop coefficient at shutdown, such that rapid flooding is ensured in a common interaction with the gas separator 3 that empties via the return conduit 9. Typical pressure drop coefficients (envisaged here for the delivery pump are less than ζ=5, especially less than ζ=3.

In normal operation or regular operation of the electrolyzer 1, the electrolysis module 3 is supplied with an electrolysis stream, such that water is converted to hydrogen H2 and oxygen as product gas in the electrolysis module 3. Hydrogen H2 is fed to the gas separator 3 in a phase mixture with water as product gas, with separation of the water from hydrogen H2 in the gas separator 3. In shutdown operation, the electrolysis stream is stopped, and a safety shutdown is initiated. Water is driven here automatically out of the gas separator 3 into the electrolysis module 3 owing to the height differential Δh, such that the electrolysis module 3 is completely flooded with water. The electrolysis module is automatically flooded here with water until the fill level LS of the water in the gas separator 3 and the fill level LM in the electrolysis module are balanced. A safe steady-state condition is thus achieved, and the electrolysis module 5 with the critical components such as membrane and electrodes are soaked in water. Running-dry is inherently prevented, in particular without having to resort to active electrical supply systems or redundant backup solutions.

The flooding concept of the invention may be applied flexibly to more complex electrolyzers 1 with regard to safety-related design and configuration. This is illustrated by way of example in FIG. 2 with reference to an electrolyzer 1 having several electrolysis modules 3a, 3b, 3c. Three electrolysis modules 3a, 3b, 3c are envisaged here, which are connected to the gas separator 3 via a common product flow conduit 7. On the outlet side of the electrolysis modules 3a, 3b, 3c, there is a respective conduit for this purpose opening into the common product flow conduit 7. In addition, the electrolysis modules 3a, 3b, 3c are connected to the return conduit 9 via a respective terminal conduit 15a, 15b, 15c. A closed-loop control valve 17a, 17b, 17c is provided in each of the terminal conduits 15a, 15b, 15c, such that individual actuation is achieved. The closed-loop control valves 15a, 15b, 15c are mechanically designed for a minimum flow below which the flow cannot be reduced under closed-loop control, such that rapid and largely unhindered backflow through the return flow conduit 9 is achievable for flooding of one or more of the electrolysis modules 3a, 3b, 3c. In the case of this electrolyzer 1 as well, in the case of an emergency, water is then automatically driven out of the gas separator 3 into the electrolysis module 3 owing to the height differential Δh, such that the electrolysis module 3 is completely flooded with water.

A diagram with the progression of the fill level L over time in the event of a safety shutdown is shown in simplified form in FIG. 3, in order to illustrate the principle. Plotted on the abscissa is the time t, and on the ordinate the level L that characterizes the fill level of the corresponding component with water. Starting from a time to, coming from normal operation, a shutdown operation of the electrolyzer 1 is initiated. At this juncture, there is a level LS in the gas separator 5 and a level LM in the electrolysis module LM. In this context, LS>LM, such that, initially in the electrolysis plant 1, a correspondingly high differential pressure is available as driving force owing to the predetermined height differential Δh for rapid flooding by level balancing.

In shutdown operation, at time t0, the electrolysis stream is stopped and a safety shutdown is initiated. Water is driven here automatically out of the gas separator 3 into the electrolysis module 3 owing to the height differential Δh, and the electrolysis module 3 is rapidly flooded with water. Flooding proceeds automatically with water until the fill level LS of water in the gas separator 5 and the fill level or the level LM in the electrolysis module 3 are balanced. The fill level or level LS of water in the gas separator 5 decreases with time t, whereas the fill level or level LM in the electrolysis module 3 increases correspondingly until the two fill levels LM and LS are the same. Level balancing is thus brought about within a short time, such that a time tA at which the flooding process is complete is determined. This period of time tA for level balancing, depending on the design of the electrolyzer 1, is only about 60-120 seconds up to a few minutes. This is sufficiently rapid to reliably prevent running-dry.

In the event of a sudden stoppage of the power supply and hence the electrolysis process, gas and water will separate in the electrolysis module 3. A certain water level will be established in the electrolysis module 3. Because the gas separator 3 in the electrolysis plant is disposed at an appropriate height differential Δh well above the electrolysis module 3 and the delivery pump 13 and further flow components are each designed with a low pressure drop coefficient ζ, sufficiently rapid flow through the conduction pathway through the return flow conduit 9 is possible, and very rapid level balancing takes place automatically. The height differential Δh is adjusted in accordance with the effective pressure drop coefficient ζeff of the overall flow pathway through the return conduit 9 including any flow elements present, such as pumps or valves, and greater or smaller values can accordingly be chosen in the design of an electrolyzer 1.

The invention provides a self-regulating flooding concept for an electrolyzer 1 with very high reliability; failure of active components is impossible since no active components are employed. The plant reliability of an electrolyzer 1 and effective protection of an electrolysis module 3 from running dry is specifically also maintained in possible fault situations, for instance a power failure, failure of the pump actuation, failure of the closed-loop control valve actuation, incorrect operation or pump damage. Moreover, a very simple and inexpensive solution is thus provided since no complex additional equipment is required, but merely the controlled and intelligent utilization of the existing equipment and the design of the electrolyzer 1. The use of the concept is possible and advantageous in particular for any electrolyzer—atmospheric or pressurized—with a pump arrangement in the circuit.

1. An electrolyzer for production of hydrogen (H₂) and oxygen (O₂) as product gases, having an electrolysis module and having a gas separator designed for phase separation of the product gas from water, in which the electrolysis module is connected to the gas separator via a product flow conduit for the product gas, and in which a return conduit having a delivery pump for the water removed is provided, which connects the gas separator to the electrolysis module, characterized in that the gas separator is designed and disposed at a height differential (Δh) above the electrolysis module such that, in an event of a shutdown, the electrolysis module is automatically floodable with water, driven solely by the height differential (Δh), wherein the delivery pump at shutdown has a small pressure drop coefficient ζ such that, acting together with the gas separator which is emptiable via the return conduit, rapid flooding in a shut-down state is assured.

2. The electrolyzer as claimed in claim 1, in which the gas separator is configured as a horizontal vessel, such that a large surface area is provided as phase interface between liquid and gaseous phase.

3. The electrolyzer as claimed in claim 1, in which the return conduit opens into a lower region of the electrolysis module.

4. The electrolyzer as claimed in claim 1, in which the height differential (Δh) is adjusted such that a driving pressure differential provided for the flooding is at least 0.05 bar to 0.5 bar, especially 0.1 bar.

5. The electrolyzer as claimed in claim 1, in which the pressure drop coefficient ζ of the delivery pump is less than ζ=5.

6. The electrolyzer as claimed in claim 1, in which two or more electrolysis modules are provided, which are connected to the gas separator via a common product flow conduit.

7. The electrolyzer as claimed in claim 6, in which the electrolysis modules are connected to the return conduit via a respective terminal conduit in which there is disposed a closed-loop control valve.

8. The electrolyzer as claimed in claim 7, in which the closed-loop control valve is designed mechanically for a minimum flow below which the flow cannot be reduced under closed-loop control.

9. A method of operating an electrolyzer, in which an electrolyzer as claimed in claim 1, and in which an electrolysis stream is supplied to an electrolysis module in regular operation, such that water is converted to hydrogen (H₂) and oxygen as product gases in the electrolysis module, wherein product gas is fed to a gas separator in a phase mixture of water and product gas, wherein water is separated from product gas in the gas separator, and wherein, in shutdown operation, the electrolysis stream is stopped and a safety shutdown is initiated, which is characterized in that water is driven out of the gas separator automatically through the return conduit into the electrolysis module solely on account of the height differential (Δh), wherein water flows through a shut-down delivery pump and the electrolysis module is flooded, wherein rapid flooding is ensured in the shut-down state.

10. The method as claimed in claim 9, in which there is autonomous flooding with water until a fill level of water in the gas separator and the electrolysis module is balanced.
